(19) United States
(12) Patent Application Publication
(10) Pub. No.: US 2025/0353319 A1
(43) Pub. Date: Nov. 20, 2025

(54) LIQUID STORAGE MEMBER FOR COATING TOOLS

(71) Applicant: MITSUBISHI PENCIL COMPANY, LIMITED, Tokyo (JP)

(72) Inventors: Saki TANAKA, Tokyo (JP); Koji TAKADA, Tokyo (JP); Shuji ICHIKAWA, Tokyo (JP)

(73) Assignee: MITSUBISHI PENCIL COMPANY, LIMITED, Tokyo (JP)

(21) Appl. No.: 18/833,481

(22) PCT Filed: Jan. 24, 2023
(86) PCT No.: PCT/JP2023/002104

§ 371 Date: Mar. 10, 2025

(30) Foreign Application Priority Data
Feb. 2, 2022 (JP) 2022-014793
Apr. 4, 2022 (JP) 2022-062488

(51) Int. Cl. B43K 7/02

(52) U.S. Cl. CPC B43K 7/02

(57) ABSTRACT

Provided is a liquid storage member for coating tools that uses a paper material, having an ink follower filled at the rear end part of a liquid storage tube made of paper, and preventing leakage and backflow of the ink follower. The liquid storage member for coating tools according to the present invention comprises: a liquid storage tubes using a paper base material; and an ink follower having a yield stress of 16 Pa or more, and preferably, a phase angle of 35° or more when a shear strain amplitude at 25° C. and 1 Hz is 0 to 30%. The liquid storage member for coating tools follower is suitable as a paper refill for a writing tool.

### TECHNICAL FIELD

The present invention relates to an ink follower that is filled into the rear end of ink in a liquid storage tube made of paper in a liquid storage member for coating tools that uses paper material.

### BACKGROUND ART

Transparent or translucent plastics such as polypropylene have traditionally been used for the ink storage member of writing tools such as ballpoint pens. However, recently, there has been growing momentum toward addressing global environmental issues, such as by reducing the use of plastic, and proposals have been made to eliminate the use of plastic for the various parts that is composed in writing tools.

For example, Patent Document 1 discloses an ink storage member for a writing tool that uses an ink storage tube with a multi-layer structure being formed by laminating one or more other resin layers on the inside of a storage tube base molded from a biodegradable resin.

According to this document, it is stated that the storage tube base formed from a biodegradable resin will biodegrade over time, and therefore can contribute to reducing the amount of waste disposal.

On the other hand, there has also been a proposal for a writing tool equipped with a shaft cylinder formed by spirally molding a composite material made by laminating a synthetic resin having barrier properties or a metal such as aluminum onto a paper base material (Patent Literature 2).

In order to improve water resistance and gas barrier properties, this shaft cylinder has a structure in which an aluminum foil label paper with a kraft paper backing and a liner paper are layered on the outer surface of the shaft cylinder, and then a polyethylene layer is layered on the inner surface, followed by a polyester film having an aluminum vapor deposition film on the outer surface. According to Patent Literature 2, by using a composite material including a paper base material for the shaft cylinder, it is possible to provide a writing tool that can achieve low pollution while maintaining durability.

Patent Literature 3 discloses a liquid storage member for coating tools having at least three layers, including an inner layer of a paper base material, a paper base laminate including an intermediate layer that is a metal layer or a silica vapor deposition layer formed on the outer circumferential surface of the inner layer, and an outer layer made of a paper base material formed on the outer circumferential surface of the intermediate layer. In the liquid storage member, the paper base laminate and the outer layer are wound in a spiral shape while being in contact with each other so that their adjacent surfaces do not overlap, and the seams between the outer layers and the seams between the paper base laminates are spaced apart by 1 mm or more and half the width of the outer layer or less, thereby preventing ink leakage.

Patent Literature 4 discloses an ink storage member for a writing tool, in which an ink storage tube is formed using paper as a base material, and one end of the ink storage tube is connected to a connection part formed on a writing member or a relay member supporting the writing member. The ink storage member provides a practical writing tool by providing a locking means at the connection part of the relay member supporting the writing member, which can ensure a certain connection strength with the ink storage tube.

### CITATION LIST

### Patent Literature

Patent Literature 1: JP 2001-146091 A
Patent Literature 2: JP S62-70097 A
Patent Literature 3: JP 2021-16976 A
Patent Literature 4: JP 2020-172044 A

### SUMMARY OF INVENTION

### Technical Problem

However, when ink and ink follower are filled into the ink storage tube aiming at the plastic-free design, the adhesion and friction resistance between the inner wall of the ink storage tube and the ink follower are insufficient, so the ink follower may flow back and splash or leak in the ink. In addition, when a certain amount of ink is consumed by writing, the inner wall of the ink storage tube becomes wet with ink, which weakens the adhesion between the follower and the inner wall of the ink storage tube and makes it slippery, which makes the ink follower more likely to flow back or leak, adversely affecting not only the performance of the writing tool but also its appearance. For this reason, it was necessary to develop an ink follower that exhibits stable followability.

An object of the present invention is to provide a liquid storage member for coating tools that can improve the performance of an ink follower and suppress leakage and backflow phenomena of the ink follower.

### Solution to Problem

The liquid storage member for coating tools of the present invention is characterized by comprising a liquid storage tube using a paper base material, and an ink follower having a yield stress of 16 Pa or more, filled in the liquid storage tube.

The ink follower preferably has a phase angle of 35° or more when the shear strain amplitude at 25° C. and 1 Hz is 0 to 30%.

Preferably it is a paper refill for a writing tool.

### Advantageous Effects of Invention

In the present invention, the ink follower has a yield stress of 16 Pa or more, and preferably a phase angle of 35° or more when the shear strain amplitude at 25° C. and 1 Hz is 0 to 30%. By filling a liquid storage tube using a paper base material with the ink follower, leakage or backflow of the ink follower can be suppressed even if the coating tool is placed facing up after being mounted on the coating tool.

### BRIEF DESCRIPTION OF DRAWINGS

FIG. 1 shows one embodiment of a refill including a liquid storage member for coating tools according to the present invention. FIG. 1(a) is a front view of the external appearance of the refill, and FIG. 1(b) is a cross-sectional view taken along line A-A of the refill.

FIG. 2 shows a three-layer structure of an inner layer, an intermediate layer, and an outer layer constituting the liquid storage member for coating tools according to the present invention. FIG. 2(a) shows an embodiment having an adhesive layer between the inner layer and the intermediate layer, FIG. 2(b) shows an embodiment having an adhesive layer between the intermediate layer and the outer layer, and FIG. 2(c) shows an embodiment having an adhesive layer between the intermediate layer and the outer layer.

### DESCRIPTION OF EMBODIMENTS

### [Liquid Storage Member for Coating Tools]

The liquid storage member for coating tools of the present invention will be described in detail below with reference to the drawings.

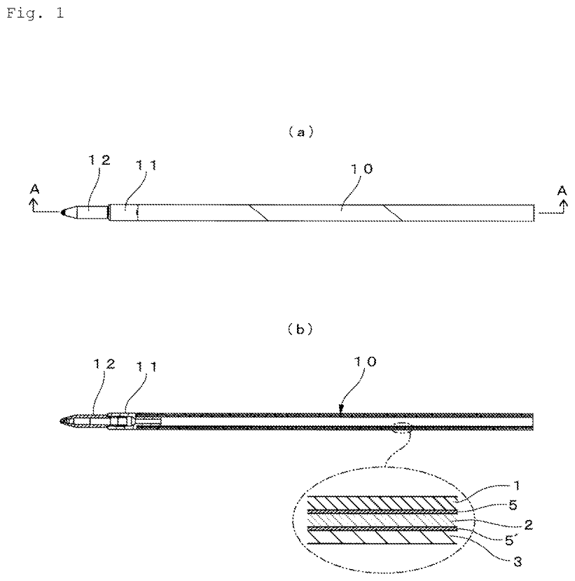

FIG. 1 shows an example of the configuration of a refill including a liquid storage member for coating tools 10 of the present invention, where FIG. 1(a) shows a front view of the exterior of the refill, and FIG. 1(b) shows a cross-sectional view of the refill taken along line A-A.

In FIG. 1, for example, a refill housed in the shaft cylinder of a ballpoint pen comprises a liquid storage member for a coating tool 10 (hereinafter simply referred to as “liquid storage member 10”) which is a long, thin, cylindrical ink storage tube made of paper and which contains ink (not shown), a joint 11 attached to the tip of this liquid storage member 10, and a ballpoint pen tip 12 attached to the tip of the joint 11 as a writing member.

Specifically, the joint 11 is formed with a cylindrical rear end part that is joined to the liquid storage member 10, and a cylindrical front end part having an outer diameter larger than that of the rear end part, and the ballpoint pen tip 12 is attached to this front end part. Also, an adhesive is applied in advance to the rear end part of the joint 11 to provide a certain bonding strength to the joint part with the liquid storage member 10, and in this state, the rear end part of the joint 11 is pressed into the front end of the liquid storage member 10 to bond the joint 11 and the liquid storage member 10. This connects the liquid storage member 10 and the ballpoint pen tip 12 via the joint 11 so that ink can flow therethrough.

The liquid storage member 10 includes a liquid storage tube using a paper base material, and an ink follower having a yield stress of 19 Pa or more that fills the liquid storage tube.

### [Ink Follower]

The ink follower will now be described in detail.

The ink follower may be a water-insoluble non-volatile organic substance having a yield stress of 16 Pa or more. Specifically, a water-insoluble non-volatile organic substance having a yield stress of 16 Pa or more that contains a base oil as a main component and contains a thickener, a surfactant, an antioxidant, etc. is used.

The base oil is a main component of the ink follower, and is, for example, mineral oil, poly-α-olefin (PAO), polybutene, or silicone oil.

Mineral oils are obtained from petroleum and are called mineral oil, petrolatum, paraffin, liquid paraffin, etc. Commercially available mineral oils include, for example, Diana Process Oil PW-90, PW-150, PW-380, and NR-26 (manufactured by Idemitsu Kosan Co., Ltd.), Barrel Process Oil B-05, P-2200 (manufactured by Matsumura Oil Co., Ltd.), etc.

Poly-alpha-olefin (PAO) is a synthetic oil obtained by polymerizing alpha-olefins. The alpha-olefin, which is a terminal alkene, becomes the reaction initiation site, forming a branched structure within the molecule. Since this branched structure contributes to the flexibility, the viscosity and the viscoelasticity of the ink follower can be adjusted by appropriately selecting the alpha-olefin. Examples of alpha-olefins include ethylene, propylene, 1-butene, 3-methyl-1-butene, 1-pentene, 1-hexene, 4-methyl-1-pentene, 1-octene, 1-decene, 1-dodecene, 1-tetradecene, 1-hexadecene, 1-octadecene, and 1-eicosene.

From the viewpoint of maintaining the performance of the coating tool over a long period of time, the polybutene used is a non-volatile polybutene having a number average molecular weight of 600 or more. Specifically, commercially available products such as Nissan Polybutene 200N (manufactured by NOF Corp.), Polybutene 30N (manufactured by NOF Corp.), Polybutene 015N (manufactured by NOF Corp.), Polybutene HV-15 (manufactured by Shin Nippon Chemical Co., Ltd.) and 35R (manufactured by Idemitsu Kosan Co., Ltd.) are used.

As the silicone oil, for example, commercially available products such as KF-54 (manufactured by Shin-Etsu Chemical Co., Ltd.), KF-96 (manufactured by Shin-Etsu Chemical Co., Ltd.), TSF451 series, TSF456 series, and TSF458 series (all manufactured by GE Toshiba Silicones Co., Ltd.) can be used.

These base oils have a kinematic viscosity at 40° C. in accordance with JIS K2283:2000 of 1 to 30,000 mm²/s. These base oils may be used alone or in combination of two or more kinds, and the amount used is 70 to 99.8% by weight, preferably 85 to 99.5% by weight, based on the total weight of the ink follower.

In addition to the base oil, the ink follower contains additives such as a thickener, a surfactant, and an antioxidant, as appropriate.

A thickener is an ingredient added during the manufacture of grease, dispersing fine solids in the base oil to give it semi-solid properties. The thickener has affinity with the base oil, and by creating a three-dimensional network structure that contains the base oil, it keeps the ink follower in a static state, and when shear is applied, it breaks down and softens, giving it a viscoelastic effect.

Thickeners are classified into soap type and non-soap type (inorganic and organic). Soap type includes calcium soap, lithium soap, lithium complex soap, aluminum complex soap, etc. Non-soap type (inorganic) includes silica gel and organic bentonite, and non-soap type (organic) includes polytetrafluoroethylene (PTFE), polyurea, sodium terephthalamate, etc. As the thickener, commercially available products such as DYNARON 6200P (olefin crystalline-ethylenebutylene-olefin crystalline block copolymer; manufactured by JSR Corporation), DYNARON 8300P (styrene-ethylenebutylene-styrene block copolymer; manufactured by JSR Corporation), lithium stearate (manufactured by Kawamura Chemical Industries Co., Ltd.), AEROSIL R202 (manufactured by Nippon Aerosil Co., Ltd.), and AEROSIL R974 (manufactured by Nippon Aerosil Co., Ltd.) can be used.

When these additives are used, the amount of addition varies depending on the conditions of heating and stirring or heating and kneading during the production of the ink follower, and is usually about 0.2 to 30%, preferably 0.5 to 15%, based on the total amount of the ink follower.

These thickeners can be used alone or in combination of two or more. The total amount of the thickeners (A) may be sufficient to make the ink follower semi-solid, and the A/B ratio relative to the amount of the base oil (B) is about 0.2 to 30.0, preferably 1.0 to 10.0.

The ink follower may contain other components such as a surfactant and an antioxidant.

The surfactant and antioxidant are added while adjusting the phase angle indicating the viscoelasticity of the ink follower.

The yield stress of the ink follower in the present invention is 16 Pa or more, preferably 16 to 100 Pa, and more preferably 16 to 50 Pa. The yield stress is the limit stress at which the ink follower suddenly starts to flow and transitions from elastic deformation to fluid deformation when a certain external force or more is applied to the ink follower. In other words, the ink follower in the present invention behaves like a solid and does not flow when subjected to a small stress of less than 16 Pa, but flows when subjected to 16 Pa or more.

It is preferable that the ink follower has a phase angle of 35° or more when the shear strain amplitude at 25° C. and 1 Hz is 0 to 30%

Shear strain is one of the dynamic viscoelastic properties, and is a measurement of the shear deformation of the ink follower. The measurement of shear deformation is the ratio of the deformation to the strain in the gap between the flat sample and the measurement table. Specifically, the ink follower, which is the sample, is made flat and placed on the measurement table, and a load is applied to it so that it does not slacken and it is held on the measurement table. In this state, the vibrator connected to the sample via a shaft is driven to apply dynamic stress to the sample. When the dynamic stress is applied to the sample as a stimulus by driving the vibrator, dynamic strain occurs in the sample in response. When the dynamic stress and dynamic strain are converted into electrical signals from the respective detectors and output, two waveforms (phases) are lined up on the time axis. The ratio of the stress peak value and strain peak value of the waveform is taken as the shear strain, and the phase angle (°) at shear strain amplitudes of 0 to 30% is calculated. The phase angle indicates how much the sample's response is delayed with respect to the addition of strain.

When the phase angle is 35° or more when the shear strain amplitude is 0 to 30% at 25° C. and 1 Hz, the ink follower has excellent tracking and impact resistance. On the other hand, if the phase angle is less than 350, the ink follower becomes sufficiently viscous (gelled) and loses fluidity, but has poor impact resistance.

When the shear strain amplitude of the ink follower at 25° C. and 1 Hz is 0 to 30%, the phase angle is more preferably 35 to 80°.

The properties of the ink follower can be optimized by selecting the types and amounts of base oil and thickener used, as well as by selecting the manufacturing conditions.

The ink follower is produced by heating and stirring or heating and kneading the base oil, thickener, and other components. The heating time and the number of times of stirring and kneading are appropriately adjusted depending on the type of base oil, thickener, etc., and the required viscoelasticity. The obtained ink follower may be further kneaded again with a dispersing machine such as a roll mill or kneader, or heated to adjust the viscoelasticity.

### [Liquid Storage Tube Using Paper Base Material]

Next, the liquid storage tube using a paper base material will be described in detail.

A liquid storage tube using a paper base material (hereinafter simply referred to as a “liquid storage tube”) is filled with ink, and then the rear end of the ink is filled with the ink follower. The ink may be any known water-based or oil-based coating liquid without any particular restrictions.

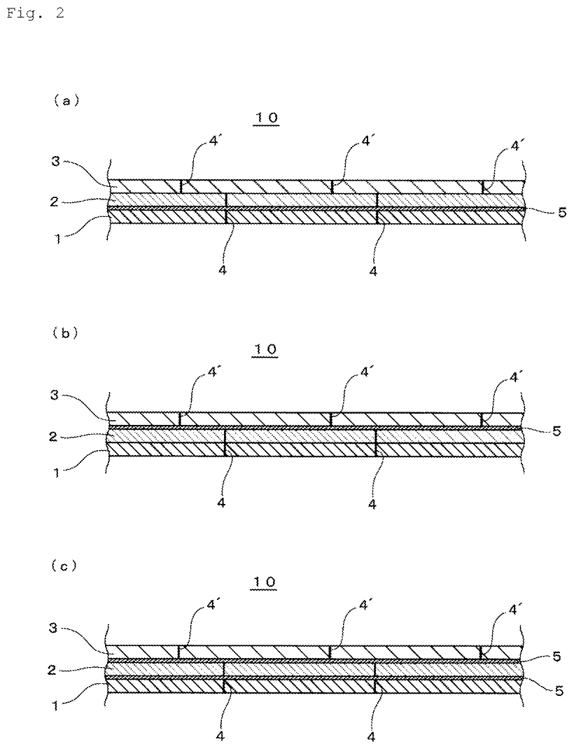

The liquid storage tube has at least three layers, an inner layer 1, an intermediate layer 2, and an outer layer 3, which are in contact with the liquid, and has an adhesive layer 5 containing a polyolefin resin (hereinafter simply referred to as “adhesive layer 5”) between at least one of the inner layer 1 and the intermediate layer 2 or the intermediate layer 2 and the outer layer 3. FIG. 2c shows a form having an adhesive layer 5 both between the inner layer 1 and the intermediate layer 2, and between the intermediate layer 2 and the outer layer 3. Of such a three-layer structure, the inner layer 1 and the intermediate layer 2 are a paper base laminate, which is a composite material in which a metal layer or a silica vapor deposition layer is laminated on the surface of a paper base. As described above, the adhesive layer 5 may be interposed in the paper base laminate.

As the paper base material constituting the inner layer 1, various well-known papers can be used, such as fine paper, medium quality paper, one-sided glossy paper, kraft paper, one-sided glossy kraft paper, bleached kraft paper, paperboard, white paperboard, liner, lightly coated paper, coated paper, art paper, cast coated paper, glassine paper, parchment paper, and vulcanized fiber.

The density of these paper base materials is preferably 0.8 g/cm 3 or more. By using a paper base material with a density of 0.8 g/cm 3 or more, sufficient water resistance and oil resistance can be imparted.

The paper base material constituting the inner layer 1 is preferably glassine paper, parchment paper or vulcanized fiber and has a density of 0.8 g/cm 3 or more.

Glassine paper is a high-density, highly transparent paper, which is made by beating virgin pulp to a high degree to increase the specific surface area, and then treating the paper with a super calendar to densify it and strengthen the bonds between the cellulose fibers. In the present invention, glassine paper with a basis weight of 20 to 50 g/m² may be used. By using glassine paper as the paper base material constituting the inner layer 1, it becomes easy to impart water resistance and oil resistance. In addition, glassine paper with a basis weight of 20 to 50 g/m² may be used as the base paper, and a coating liquid such as an aqueous polyvinyl alcohol solution may be applied to one or both sides of the base paper. The thickness of the glassine paper is usually 20 to 50 μm, preferably 20 to 30 μm.

Parchment paper and vulcanized fiber are made by treating the cellulose fibers with concentrated sulfuric acid or zinc chloride solution during the manufacturing process to strengthen the direct bonds between the cellulose fibers, i.e., to increase the density of hydrogen bonds of cellulose between the cellulose fibers. Therefore, if parchment paper or vulcanized fiber is used as the paper base material constituting the inner layer 1, the generation of paper dust can be effectively suppressed.

The parchment paper used has a basis weight of, for example, 20 to 100 g/m², and preferably has improved oil resistance so that the oil absorption is 13 g/m² or less when mineral oil is used instead of water in accordance with the water absorption test method for paper and paperboard (Cobb method). The thickness of the parchment paper is usually 20 to 100 μm, preferably 20 to 60 μm.

Vulcanized fiber can be easily made thicker than parchment paper due to differences in reactivity during the manufacturing process. Therefore, it is suitable when thick paper is required as the paper base material. The thickness of vulcanized fiber is usually 0.08 to 1 mm, preferably 0.1 to 0.5 mm, taking into consideration the compressive strength of the paper tube part after the liquid storage tube is formed and ease of handling during manufacturing. In addition, the density of vulcanized fiber is higher than that of general paper tube base paper, usually 0.8 to 1.4 g/cm³, but in the present invention, it is preferable to make it 0.8 to 1.3 g/cm³, taking into consideration the strength of the paper tube part and ease of availability.

Furthermore, the parchment paper and the vulcanized fiber may be subjected to a resin impregnation treatment or a glass coating treatment, which strengthens the bonds between the cellulose fibers, and when these papers are used as the paper base material constituting the inner layer 1, the generation of paper powder can be suppressed.

The intermediate layer 2 is a metal layer or a silica deposition layer. The metal layer may be formed by adhering a metal foil such as an aluminum foil to one side of the paper substrate with an adhesive containing a polyolefin resin, or by depositing aluminum or an alloy of aluminum and zinc by electron beam deposition under vacuum.

Here, the adhesive containing a polyolefin resin used in the present invention will be described. The adhesive containing a polyolefin resin may be an adhesive made of one or more polyolefin resins, or may be an adhesive made by mixing the polyolefin resin with other resins.

Specifically, the polyolefin resin includes polyethylene ionomers, polyethylene elastomers, high density polyethylene, low density polyethylene, polypropylene ionomers, polypropylene elastomers, etc., as well as modified polyolefin resins such as maleic anhydride modified polypropylene. Among these, polypropylene ionomers and maleic anhydride modified polypropylene are preferred.

Examples of other resins that can be used include acrylic acid copolymers, ethylene-vinyl alcohol copolymers (EVOH), ethylene-acrylic acid copolymers (EAA), ethylene-methacrylic acid copolymers (EMAA), epoxy resins, carbodiimide crosslinking agents, ethylene-vinyl acetate copolymers, and polyvinyl alcohol.

When polyolefin resin is mixed with other resins, the ratio of polyolefin resin in the total amount of adhesive is about 60 to 97% by weight, preferably 90 to 97% by weight. Also, the ratio of polyolefin resin in the total amount of polyolefin resin and other resins is about 68 to 98% by weight, preferably 93 to 98% by weight.

The adhesive containing the polyolefin resin according to the present invention is used in the form of a dispersion or emulsion type resin liquid having a polyolefin resin or a mixture of a polyolefin resin and other resins as a base polymer. Additives such as a silane coupling agent may be added to the resin liquid as necessary. Among these, dispersion type adhesives such as polypropylene ionomer and maleic anhydride modified polypropylene are preferred from the viewpoint of excellent adhesiveness and handling.

The adhesive containing polyolefin resin is applied at least one of the position between the inner layer 1 and the intermediate layer 2, and between the intermediate layer 2 and the outer layer 3. That is, as shown in FIG. 2, an adhesive layer 5 may be provided between the inner layer 1 and the intermediate layer 2 (FIG. 2a), an adhesive layer 5 may be provided between the intermediate layer 2 and the outer layer 3 (FIG. 2b), or an adhesive layer 5 may be provided both between the inner layer 1 and the intermediate layer 2 and between the intermediate layer 2 and the outer layer 3 (FIG. 2c). By applying an adhesive containing polyolefin resin having excellent adhesion and ink resistance to paper material, the inner layer 1, the intermediate layer 2, and the outer layer 3 of the liquid storage tube are closely adhered to each other, and it is possible to prevent ink from leaking out of the liquid storage tube. Note that the ink resistance represents the degree to which the elution of the adhesive resin component into the ink can be suppressed. When an adhesive containing polyolefin resin is used, the compatibility with the ink is low, so that the polyolefin resin does not dissolve in the ink, and these effects on the ink resistance can be expected.

In the present invention, any one of the inner layer 1, the intermediate layer 2 and the outer layer 3 may be bonded together with an adhesive containing a polyolefin resin, and other adhesives, such as general-purpose adhesives based on vinyl acetate resin, acrylic resin and polyvinyl alcohol, may also be used in combination.

The adhesive containing polyolefin resin is applied in a mound near the center of the inner layer 1 or intermediate layer 2. Next, the adhesive is spread over the entire bonding surface while pressing the inner layer 1 and intermediate layer 2 together, and the two layers are bonded together without leaving any air bubbles in the bonded area and without any bonding defects. After the inner layer 1 and intermediate layer 2 are bonded together, they are pressed together and fixed in place until the adhesive hardens.

The adhesive containing a polyolefin resin is applied to the inner layer 1 or the intermediate layer 2 in an amount of about 5 to 50 g/m², preferably 5 to 25 g/m².

The inner layer 1 and intermediate layer 2 of the liquid storage tube may be formed of a paper base material laminate using a paper base material and a metal layer or a silica vapor deposition layer of the same thickness, or may be formed by an appropriate combination of paper base material laminates using paper base materials and metal layers or silica vapor deposition layers of different thicknesses.

In the paper base laminate, the ratio of the thickness of the paper base to the thickness of the metal layer or the silica vapor deposition layer is about 2/1 to 1200/1.

After the intermediate layer 2 is adhered to the inner layer 1, the paper substrate laminate is cut to a width of 4 to 20 mm using a bobbin slitter or the like to obtain a belt-shaped sheet, a paper substrate laminate. Next, the paper substrate laminate is spirally wound around a mandrel (paper tube manufacturing machine) with the inner layer 1 facing inward. In order to facilitate the removal of the mandrel after the inner layer 1, intermediate layer 2, and outer layer 3 are formed, it is preferable to treat the surface of the mandrel with a suitable lubricant in advance, or to apply an appropriate amount of lubricant to the surface of the inner layer 1 (paper substrate) that is wound around the mandrel. Then, to bond the outer layer 3, an adhesive such as an adhesive containing a polyolefin resin is applied to the outer intermediate layer 2.

The paper base laminate is a strip-shaped sheet cut to a width of 4 to 20 mm, preferably 5 to 15 mm. By spirally winding such a wide paper base laminate, the required length of the liquid storage member 10 can be achieved without winding it many times, and as a result, the contact surface between the paper base materials, i.e., the number of seams 4, can be reduced, and leakage of the liquid contained in the liquid storage tube can be suppressed.

A paper base material is further spirally wound around the outside of the intermediate layer 2 to form the outer layer 3. The outer layer 3 is also preferably formed from a paper base material having a width of 4 to 20 mm, specifically 6 to 15 mm. This is because, as with the paper base material laminate, by reducing the number of seams 4′, leakage of the liquid in the liquid storage member 10 can be prevented.

For the paper base material constituting the outer layer 3, the paper base material constituting the inner layer 1 described above can be used.

The outer layer 3 may be attached to the intermediate layer 2 using an adhesive containing the polyolefin resin. The application method and application amount of the adhesive containing the polyolefin resin in this case are similar to those for the inner layer 1 or the intermediate layer 2.

The ratio of the thicknesses (μm) of the inner layer 1, intermediate layer 2 and outer layer 3 is usually 20-60:0.025-12:50-200, preferably 20-30:0.025-12:50-200.

As described above, the liquid storage tube according to the present invention has a structure in which the paper base laminate is wound in a spiral shape along the longitudinal direction of the liquid storage tube with adjacent surfaces in contact with each other so as not to overlap. Even if adjacent surfaces overlap at the contact points of the paper base laminates, i.e., at the seam 4, the overlap width is a maximum of 1 mm. By bringing the seam 4 into contact with each other so as not to overlap, or by making the overlap width a maximum of 1 mm, leakage of liquid from the seam 4 can be suppressed. If the overlap width at the seam 4 exceeds 1 mm, a step will be generated at the overlapping part, which may lead to leakage of liquid.

Similarly to the paper base laminate, the outer layer 3 is preferably wound with its adjacent surfaces in contact with each other. The seam 4′ between the outer layers 3 and the seam 4 between the paper base laminate are preferably spaced apart from each other by a distance of 1 mm or more and half or less of the width of the paper base laminate or the outer layer 3 along the longitudinal direction of the liquid storage member 10, and more preferably spaced apart by a distance of 3 mm or more and half or less of the width of the paper base laminate or the outer layer 3. Even if the seams 4′ between the outer layers 3 overlap to some extent, there is no problem of liquid leakage.

The liquid storage tube manufactured as described above is completed by forming the inner layer 1, the intermediate layer 2 and the outer layer 3, removing the mandrel, cutting the tubular molded body to the specified length required for the liquid storage member 10, and drying it for several hours under appropriate temperature and humidity.

The obtained liquid storage tube has a smaller diameter than a normal paper tube, and its outer diameter is usually 20 mm or less, preferably 15 mm or less, and more preferably 10 mm or less, and the lower limit of the outer diameter is usually 1 mm or more, preferably 2 mm or more. Such a small-diameter liquid storage member requires strict dimensional accuracy. Therefore, the smaller the outer diameter of the liquid storage tube, the more preferable it is to bring the paper base laminate and the outer layer made of the paper base into contact with each other so that adjacent surfaces of the paper base laminate do not overlap, and bring the outer layer made of the paper base into contact with each other so that adjacent surfaces of the paper base layer are in contact with each other when winding the paper base laminate and the outer layer made of the paper base into a spiral shape.

The thickness of the liquid storage tube is usually 0.07 to 0.6 mm, specifically 0.2 to 0.4 mm. By making the thickness of the liquid storage tube within this range, a sufficient amount of liquid can be contained, the barrier properties are improved, and leakage and deterioration of the liquid can be easily suppressed.

### [Coating Tool]

The coating tool of the present invention is not limited as long as it is equipped with the liquid storage member 10, and may be a writing tool of a padded type or a direct-flow type, or a cosmetic tool such as an eyeliner, mascara, or concealer, but is preferably a writing tool. Therefore, the liquid storage member 10 is suitably used for a paper refill for a writing tool.

In the case of a writing tool, the pen tip may be any of a calligraphy brush, a soft pen, a hard pen, etc. Specific examples of writing tools are a fountain pen, a ballpoint pen, a marking pen, a felt-tip pen, a correction tool, a brush pen, etc. In this case, the ink contained in the liquid storage member 10 may be either a water-based (gel) ink or an oil-based ink, and depending on the type of pen, ink for a ballpoint pen, a pressurized ballpoint pen, or a marking pen is used.

The present invention will now be described in more detail with reference to examples, but the present invention is not limited to the following examples.

The liquid storage tubes used in the examples and comparative examples were manufactured as follows.

### Manufacturing Example 1

A 25 μm thick glassine paper (basis weight 25 g/m², density 1.0 g/cm³) and a 6.5 μm thick aluminum foil were bonded together with an adhesive containing polyolefin resin (Chemipearl S500; manufactured by Mitsui Chemicals, Inc.) to produce a bonded paper having an adhesive layer thickness of 6.5 μm and a total thickness of 38 μm. The bonded paper was cut to a width of 13 mm using a bobbin slitter.

The adhesive containing the polyolefin resin was applied to the aluminum foil side, which was the outer layer of the rectangular bonded paper, at 12 g/m² using a roll-type coating tool, and the bonded paper was spirally wound in a single layer around the outer circumferential surface of the mandrel of a paper tube manufacturing machine (Langston) so that the glassine paper was on the inside.

Next, a 66 μm thick coated paper (basis weight 85 g/m²) cut to a width of 13 mm using a bobbin slitter was spirally wound in single layer on the aluminum foil which was the outer layer of the bonded paper.

At this time, the bonded paper and the coated paper were wound so that their adjacent surfaces were butted against each other without overlapping each other, and the bonded paper and the coated paper were wound so that the contact points between the bonded paper and the coated paper were spaced 3 mm apart in the longitudinal direction.

The obtained spiral tube was cut to a length of 89.3 mm to obtain a paper liquid storage tube (paper tube 1) having an inner diameter of 3.8 mm.

### Manufacturing Example 2

A liquid storage tube (paper tube 2) was obtained in the same manner as in Manufacturing Example 1, except that a rectangular bonded paper was spirally wound double, instead of single, around the outer circumferential surface of the mandrel of a paper tube manufacturing machine (Langston). That is, in Manufacturing Example 2, a rectangular adhesive paper was wound so that adjacent surfaces of the bonded paper butted against each other without overlapping, and then another rectangular bonded paper was wound on top of the rectangular bonded paper so that adjacent surfaces of the bonded paper butted against each other without overlapping.

### Manufacturing Example 3

A liquid storage tube (paper tube 3) was obtained in the same manner as in Manufacturing Example 2, except that instead of glassine paper, a 25 μm thick parchment paper (basis weight 25 g/m², density 1.0 g/cm³) and a 6.5 μm thick aluminum foil were bonded together with an adhesive containing polyolefin resin.

### Manufacturing Example 4

A liquid storage tube (paper tube 4) was obtained in the same manner as in Manufacturing Example 2, except that the bonded paper used was a 25 μm thick glassine paper (basis weight 25 g/m², density 1.0 g/cm³) on which a 0.4 μm thick silica vapor deposition layer was formed instead of aluminum foil.

### Manufacturing Example 5

A liquid storage tube (paper tube 5) was obtained in the same manner as in Manufacturing Example 2, except that the adjacent surfaces of the coated paper were not butted together, but were overlapped by 1 mm when wound.

### Manufacturing Example 6

A liquid storage tube (paper tube 6) was obtained in the same manner as in Manufacturing Example 2, except that the distance between the contact points of the bonded papers and the contact points of the coated papers was 5 mm instead of 3 mm.

The inks used in the examples and comparative examples were prepared according to the following formulations.

### <Coating Solution 1>(Total Amount 100% by Mass)

Spiron Violet C-RH [manufactured by Hodogaya Chemical Industry Co., Ltd.]8%

Spiron Yellow C-GNH [manufactured by Hodogaya Chemical Industry Co., Ltd.]5%

Printex #35 [manufactured by Degussa Japan Co., Ltd.]8%

Polyvinyl butyral BL-1 [Sekisui Chemical Co., Ltd.]4%

Polyvinyl butyral BH-3 [manufactured by Sekisui Chemical Co., Ltd.]0.7%

Hi-Lac 110H [Hitachi Chemical Co., Ltd.]10%

SOLSPERSE 28000 [manufactured by Lubrizol Japan Co., Ltd.]1%

(Acid value: 29, weight average molecular weight: about 3400)

Benzotriazole 0.5%

3-Methoxy-3-methyl-1-butanol 62.8%

### <Coating Solution 2>(Total Amount 100% by Mass)

FUJI RED 2510 [manufactured by Fuji Pigment Co., Ltd.]8%

Joncryl 63J [BASF Japan Ltd.]6%

Xanthan gum KELSAN S [manufactured by Sansho Co., Ltd.]0.32%

Isopropyl phosphate 0.5%

Bioden S [manufactured by Nippon Soda Co., Ltd.]0.2%

Benzotriazole 0.3%

Triethanolamine 1.4%

Propylene glycol 15%

Ion-exchanged water 68.28%

### <Coating Solution 3>(Total Amount 100% by Mass)

Vinyblan GV5651 [manufactured by Nissin Chemical Industry Co., Ltd.]80%

(Polyvinyl acetate emulsion; solids content 40%)

Acid dye Red No. 227 0.22%
Yellow No. 4 0.34%
Blue No. 1 0.08%

Purified water 19.36%

The ink followers used in the examples and comparative examples were prepared as follows.

The method for preparing the ink follower used in Example 1 will be shown as a representative example.

As the base oil, 55.5% by mass of polybutene 015N (polybutene; manufactured by NOF Corporation) and 40.0% by mass of Diana Process Oil PW-380 (mineral oil; manufactured by Idemitsu Kosan Co., Ltd.) were mixed with 4.5% by mass of AEROSIL R202 (hydrophobic fumed silica; manufactured by Nippon Aerosil Co., Ltd.) as a thickener, and the mixture was heated and kneaded using a planetary mixer and a roll mill to prepare an ink follower. This ink follower is designated as ink follower 1.

The ink followers used in Examples 2 to 9 and Comparative Examples 1 to 3 were prepared using the base oil and thickener in the types and amounts shown in Table 1, and under the kneading conditions shown in Table 1. These are referred to as ink followers 2 to 12.

The evaluation methods for the ink followers 1 to 12 used in the respective examples and comparative examples are shown below.

### [Yield Stress]

Yield stress (τ₃) is the shear stress when the shear rate is zero. Shear stress (τ) can be calculated from the shear rate (D) and the measured viscosity (25° C.). Yield stress (τ₀, unit Pa) is the square of the intercept of a linear straight line plotted from the square roots of the shear rate-shear stress (measured value) at three or more points.

### [Phase Angle]

The ink follower (sample) was placed on the measurement table, and a load was applied to hold the sample on the measurement table so that it would not slacken. In this state, a vibrator (MCR-302, manufactured by Anton Paar Co., Ltd.) connected to the sample via a shaft was driven at 25° C. and 1 Hz to apply dynamic stress to the sample. The ratio of the stress peak value to the strain peak value in the two waveforms (phases) converted from the dynamic stress and dynamic strain was taken as the shear strain, and the phase angles (°) at shear strain amplitudes of 10%, 25%, and 45% were obtained.

Table 1 shows the phase angles (°) of the shear strain amplitudes of 10%, 25% and 45% at 25° C. and 1 Hz for the ink followers used in Examples 1 to 7 and Comparative Examples 1 to 3.

### [Backflow of Ink Follower]

(i) Backflow of the Ink Follower when No Writing is Done

A paper liquid storage tube was filled with ink and an ink follower, and a joint and a pen tip with a ball diameter of 0.7 mm were combined to make a refill. The refill was left to stand at 25° C. for one week with the pen tip facing up. After writing, the refill was cut along the longitudinal direction, and the backflow was judged by visually evaluating the degree of ink leakage from the rear end of the refill according to the following criteria.
A: Neither the ink nor the ink follower moved.
B: The ink follower had moved.
C: Ink follower was leaking from the rear end of the refill.
   (ii) Backflow of Ink Follower after Writing

After preparing the refill in the same manner as in (i) above, spiral writing was performed using a writing tester at a load of 100 g, a writing speed of 4.5 m/min, and a writing angle of 60° in an environment of 25° C. and 65% humidity. This was continued until the total ink consumption weight measured every 100 m reached 1.5 times or more the filled weight of the ink follower, and after writing, the pen tip was placed facing up and left to stand at 25° C. for one week. The backflow was judged according to the same criteria as in (i) above.
A: Neither the ink nor the ink follower moved.
B: The ink follower had moved.
C: Ink follower was leaking from the rear end of the refill.

### Example 1

The paper tube 1 was filled with 0.7 g of the coating liquid 1, and further filled with the ink follower 1 to a length of about 10 mm. After measuring the filling weight, the rear end of the coating liquid was sealed.

Next, a stainless steel joint was attached to the opposite side of the sealed part of the paper tube 1, and a pen tip having a ball diameter of 0.7 mm was attached to the tip of the joint to prepare a refill. The obtained refills (unwritten and written) were left at 25° C. for one week with the pen tips facing up.

### Examples 2 to 9

As shown in Table 1, ink followers 2 to 9 were filled into paper tubes 1 to 6, and refills were prepared in the same manner as in Example 1. The refills were allowed to stand under the same conditions as in Example 1.

All of the ink followers 1 to 9 had a high yield stress, and in the backflow evaluation of the ink followers, they were rated A both before and after writing.

The results of Examples 1 to 9 are shown in Table 1.

### Comparative Example 1

A refill was prepared in the same manner as in Example 2, except that the ink follower 10 was used instead of the ink follower 2 in Example 2.

In Comparative example 1, which used ink follower 8, which has a higher ratio of polybutene and a lower ratio of thickener compared to ink follower 2, the yield stress was small at 9 Pa, and in the backflow evaluation of the ink follower, leakage of the ink follower was observed, and the results were all C.

### Comparative Example 2

A refill was prepared in the same manner as in Example 5, except that the ink follower 11 was used instead of the ink follower 5 in Example 5.

In Comparative example 2, which used ink follower 11, which has a greater amount of silicone oil and a smaller amount of thickener than ink follower 5, the yield stress was small at 12 Pa, and in the backflow evaluation of the ink follower, leakage of the ink follower was observed, and the results were all C.

### Comparative Example 3

A refill was prepared in the same manner as in Example 7, except that the ink follower 12 was used instead of the ink follower 7 in Example 7.

In Comparative Example 3, which used the ink follower 12 having a greater amount of base oil and a smaller amount of thickener than the ink follower 7, the yield stress was small at 15 Pa. In the backflow evaluation of the ink follower, the ink follower was rated B when not written on, but C after writing.

The results of Comparative Examples 1 to 3 are shown in Table 1.

TABLE 1-1

| | | | Example 1 | Example 2 | Example 3 | Example 4 | Example 5 |
|---|---|---|---|---|---|---|---|
| Ink | Base oil | Polybutene 015N (polybutene; NOF Corporation) | [symbol] | | | | |
| follower | | Polybutene 30N (polybutene; NOF Corporation) | | 55.0 | | | |
| formulation | | [symbol] Process Oil [symbol] -90(Mineral oil; [symbol] | | 40.0 | | | |
| | | Kosan Co., Ltd) | | | | | |
| | | [symbol] Process Oil PW-380(Mineral oil; [symbol] | 40.0 | | | | |
| | | Kosan Co., Ltd) | | | | | |
| | | Barrel Process Oil B-05(Synthetic aromatic | | | 9 [symbol] .5 | | |
| | | hydrocarbons; [symbol] Oil Co., Ltd.) | | | | | |
| | | Barrel Process Oil P-2200(Liquid paraffin; | | | | 95.4 | |
| | | [symbol] Oil Co., Ltd.) | | | | | |
| | | KF-54 (Silicone oil; Shin- [symbol] Chemical Co., | | | | | 95.0 |
| | | Ltd.) | | | | | |
| | | KF-96 (Silicone oil; Shin- [symbol] Chemical Co., | | | | | |
| | | Ltd.) | | | | | |
| | Thickener | DYNARON 6200P ( [symbol] Corporation) | | | | 4.6 | |
| | | DYNARON 8300P ( [symbol] Corporation) | | | | | |
| | | Lithium [symbol] ( [symbol] Chemical Industries | | 2.5 | 2.5 | | |
| | | Co., Ltd.) | | | | | |
| | | AEROSIL R202 (hydrophobic [symbol] silica; Nippon | 4.5 | | 3.0 | | 5.0 |
| | | Aerosil Co., Ltd.) | | | | | |
| | | AEROSIL R974 (hydrophobic [symbol] silica; Nippon | | 2.5 | | | |
| | | Aerosil Co., Ltd.) | | | | | |

| Kneading conditions (equipment, etc.) | | Planetary | Planetary | Planetary | Planetary | Planetary |
|---|---|---|---|---|---|---|
| | | mixer | mixer | mixer | Mixer | mixer |
| | | Roll mill | Roll mill | Roll mill | Heated and | Roll mill |
| | | Heated and | Heated and | Heated and | kneaded | Heated and |
| | | kneaded | kneaded | kneaded | | kneaded |
| Coating solution | | 1 | 1 | 1 | 1 | 2 |
| Paper tube | | 1 | 2 | 2 | 3 | 4 |
| Properties of | Yield stress(Pa) | 20 | 38 | 54 | 30 | 78 |
| ink [symbol] | Phase angle(°) shear strain 10% (25° C., 1 Hz) | 55 | 67 | 46 | 40 | [symbol] |
| | Phase angle(°) shear strain 25% (25° C., 1 Hz) | 58 | [symbol] | 50 | 49 | 58 |
| | Phase angle(°) shear strain 30% (25° C., 1 Hz) | [symbol] | 69 | 50 | 50 | 58 |
| | Phase angle(°) shear strain 45% (25° C., 1 Hz) | 59 | 74 | 51 | 58 | 60 |
| Evaluation | Backflow of ink follower(25° C., no writing, | A | A | A | A | A |
| results | for one week with the pen tip facing up) | | | | | |
| | Backflow of ink follower (25° C., after writing, | A | A | A | A | A |
| | for one week with the pen tip facing up) | | | | | |

| | | | Example 6 | Example 7 | Example 8 | Example 9 |
|---|---|---|---|---|---|---|
| Ink | Base oil | Polybutene 015N (polybutene; NOF Corporation) | | | 86.2 | |
| follower | | Polybutene 30N (polybutene; NOF Corporation) | | | | 83.9 |
| formulation | | [symbol] Process Oil [symbol] -90(Mineral oil; [symbol] | | 94.0 | 10.0 | |
| | | Kosan Co., Ltd) | | | | |
| | | [symbol] Process Oil PW-380(Mineral oil; [symbol] | | | | 12.0 |
| | | Kosan Co., Ltd) | | | | |
| | | Barrel Process Oil B-05(Synthetic aromatic | | | | |
| | | hydrocarbons; [symbol] Oil Co., Ltd.) | | | | |
| | | Barrel Process Oil P-2200(Liquid paraffin; | | | | |
| | | [symbol] Oil Co., Ltd.) | | | | |
| | | KF-54 (Silicone oil; Shin- [symbol] Chemical Co., | | | | |
| | | Ltd.) | | | | |
| | | KF-96 (Silicone oil; Shin- [symbol] Chemical Co., | [symbol] | | | |
| | | Ltd.) | | | | |
| | Thickener | DYNARON 6200P ( [symbol] Corporation) | | 2.0 | 3.8 | 4.1 |
| | | DYNARON 8300P ( [symbol] Corporation) | | 4.0 | | |
| | | Lithium [symbol] ( [symbol] Chemical Industries | | | | |
| | | Co., Ltd.) | | | | |
| | | AEROSIL R202 (hydrophobic [symbol] silica; Nippon | | | | |
| | | Aerosil Co., Ltd.) | | | | |
| | | AEROSIL R974 (hydrophobic [symbol] silica; Nippon | 4.4 | | | |
| | | Aerosil Co., Ltd.) | | | | |

| Kneading conditions (equipment, etc.) | | Planetary | Planetary | Planetary | Planetary |
|---|---|---|---|---|---|
| | | mixer | mixer | mixer | mixer |
| | | Roll mill | Roll mill | Heated and | Roll mill |
| | | Heated and | Heated and | kneaded | Heated and |
| | | kneaded | kneaded | | kneaded |
| Coating solution | | 2 | 3 | 1 | 2 |
| Paper tube | | 5 | 6 | 1 | 2 |
| Properties of | Yield stress(Pa) | 61 | [symbol] | [symbol] | 19 |
| ink [symbol] | Phase angle(°) shear strain 10% (25° C., 1 Hz) | 64 | 32 | 35 | 45 |
| | Phase angle(°) shear strain 25% (25° C., 1 Hz) | 67 | 35 | 39 | [symbol] 0 |
| | Phase angle(°) shear strain 30% (25° C., 1 Hz) | 68 | 36 | 40 | 51 |
| | Phase angle(°) shear strain 45% (25° C., 1 Hz) | 70 | 44 | 46 | 55 |
| Evaluation | Backflow of ink follower(25° C., no writing, | A | A | A | A |
| results | for one week with the pen tip facing up) | | | | |
| | Backflow of ink follower (25° C., after writing, | A | B | A | A |
| | for one week with the pen tip facing up) | | | | |

[symbol]

indicates data missing or illegible when filed

TABLE 1-2

| | | | Comparative | Comparative | Comparative |
|---|---|---|---|---|---|
| | | | Example 1 | Example 2 | Example 3 |
| Ink | Base oil | Polybutene 015N (polybutene; NOF Corporation) | | | [symbol] |
| follower | | Polybutene 30N (polybutene; NOF Corporation) | [symbol] | | |
| formulation | | [symbol] Process Oil [symbol] -90(Mineral oil; [symbol] | 40.0 | | [symbol] |
| | | Kosan Co., Ltd) | | | |
| | | [symbol] Process Oil PW-380(Mineral oil; [symbol] | | | |
| | | Kosan Co., Ltd) | | | |
| | | Barrel Process Oil B-05(Synthetic aromatic | | | |
| | | hydrocarbons; [symbol] Oil Co., Ltd.) | | | |
| | | Barrel Process Oil P-2200(Liquid paraffin; | | | |
| | | [symbol] Oil Co., Ltd.) | | | |
| | | KF-54 (Silicone oil; Shin-Etsu Chemical Co., | | [symbol] | |
| | | Ltd.) | | | |
| | | KF-96 (Silicone oil; Shin-Etsu Chemical Co., | | | |
| | | Ltd.) | | | |
| | Thickener | DYNARON 6200P ( [symbol] Corporation) | | | |
| | | DYNARON 8300P ( [symbol] Corporation) | | | [symbol] |
| | | Lithium [symbol] ( [symbol] Chemical Industries | 1.0 | | |
| | | Co., Ltd.) | | | |
| | | AEROSIL R202 (hydrophobic [symbol] silica; Nippon | | 3.5 | |
| | | Aerosil Co., Ltd.) | | | |
| | | AEROSIL R974 (hydrophobic [symbol] silica; Nippon | 2.0 | | |
| | | Aerosil Co., Ltd.) | | | |

| Kneading conditions (equipment, etc.) | | Planetary mixer | Planetary mixer | Planetary mixer |
|---|---|---|---|---|
| | | Roll mill | Roll mill | Heated and |
| | | Heated and | Heated and | kneaded |
| | | kneaded | kneaded | |
| Coating solution | | 1 | 2 | 3 |
| Paper tube | | 2 | [symbol] | [symbol] |
| Properties of | Yield stress(Pa) | [symbol] | 12 | [symbol] |
| ink follower | Phase angle(°) shear strain 10% (25° C., 1 Hz) | [symbol] | 51 | 40 |
| | Phase angle(°) shear strain 25% (25° C., 1 Hz) | 60 | [symbol] | 45 |
| | Phase angle(°) shear strain 30% (25° C., 1 Hz) | [symbol] | 50 | [symbol] |
| | Phase angle(°) shear strain 45% (25° C., 1 Hz) | 71 | 64 | 47 |
| Evaluation | Backflow of ink follower(25° C., no writing, | C | C | B |
| results | for one week with the pen tip facing up) | | | |
| | Backflow of ink follower (25° C., after writing, | C | C | C |
| | for one week with the pen tip facing up) | | | |

[symbol]

indicates data missing or illegible when filed

### REFERENCE SIGNS LIST

10 Liquid storage member for coating tool
11 Joint
12 Ballpoint pen tip
1 Inner layer
2 Intermediate layer
3 Outer layer
4, 4′ Joint
5 Adhesive layer

1. A liquid storage member for coating tools comprising:
a liquid storage tube using a paper base material; and
an ink follower having a yield stress of 16 Pa or more, filled in the liquid storage tube.

2. The liquid storage member for coating tools according to claim 1, wherein the ink follower has a phase angle of 35° or more when the shear strain amplitude at 25° C. and 1 Hz is 0 to 30%.

3. The liquid storage member for coating tools according to claim 1 or 2, being a paper refill for a writing tool.
